(19) United States
(12) Patent Application Publication
(10) Pub. No.: US 2009/0230197 A1
(43) Pub. Date: Sep. 17, 2009

(54) METHOD AND APPARATUS FOR A CONTACTLESS SMARTCARD INCORPORATING A MECHANICAL SWITCH

(76) Inventor: Colin Tanner, Middlesex (GB)

Correspondence Address: BUCKLEY, MASCHOFF & TALWALKAR LLC, 50 LOCUST AVENUE, NEW CANAAN, CT, 06840, US

(21) Appl. No.: 12/049,009

(22) Filed: Mar. 14, 2008

(51) Int. Cl. G06K 19/067

(52) U.S. Cl. 235/492

(57) ABSTRACT

An apparatus and method for providing a radio frequency identification (RFID) card, the card including a card inlay; an antenna positioned on the card inlay; a RFID integrated circuit (IC) located on the card inlay; an electrode structure; a switch located on or in the card inlay and, when actuated, coupled to the antenna and the RFID IC via the electrode structure. The switch further includes a conductive layer aligned with but positioned spaced apart from the electrode structure; and a compressible material to hold the conductive layer in the spaced apart position and to compress under pressure when the switch is actuated to permit the conductive layer to contact the electrode structure.

### BACKGROUND

In various implementations, a contactless smartcard may be used to implement a proximity payment and an identity card. A contactless smartcard may typically include a radio frequency identification (RFID) integrated circuit (IC) embedded in a card-shaped plastic body. An antenna may also be embedded in the card body to receive a power signal from a card reader such as, for example, a point of sale terminal. The antenna may also be used by the RFID IC to transmit an account number, cardholder identification, and other information to the POS terminal or other card reader.

A contactless smartcard including a user-actuated switch may offer operational advantages such as enhanced security features. In some instances, a user may need to actuate the switch in order to activate the smartcard so that the smartcard may be read by a card reader. By requiring a user to actuate a switch included on the smartcard in order to activate the card, it may be possible to prevent certain security attacks against the card such as those initiated surreptitiously by reading a smartcard from a distance without the knowledge, consent, or authorization of the card holder.

However, disadvantages that may be associated with a smartcard having a user-actuated switch is that the resulting cards may include increased manufacturing costs, decreased longevity or reliability of the smartcard, and non-conformance with industry standards related to the size, configuration, and dimensions of the smartcard.

### BRIEF DESCRIPTION OF THE DRAWINGS

FIG. 1 is a simplified schematic plan view of a contactless smartcard, according to some embodiments herein;

FIG. 2 is schematic plan view of a card inlay, in accordance with some embodiments herein;

FIG. 3 is an a schematic plan view of a contactless smartcard incorporating a mechanical switch, according to some embodiments herein;

FIG. 4 is an a schematic plan view of another embodiment of a contactless smartcard incorporating a mechanical switch, according to some embodiments herein; and

FIG. 5 is an exemplary flow chart illustrating aspects of a method for manufacturing a contactless smartcard, in accordance with some embodiments herein.

### DETAILED DESCRIPTION

In general, and for the purpose of introducing concepts of embodiments of the present disclosure, a contactless smartcard herein may include a RFID IC that is activated to an operational state by a mechanical switch incorporated into the smartcard. Using an RFID IC of the type disclosed herein may provide an efficient, reliable, and cost-effective proximity payment card that includes a user-actuated switch. This disclosure a reliable and cost effective method for incorporating a user-actuated switch into a smartcard. Importantly it allows the switch to be constructed within the inner layers of the card, and then sealed from outside contaminates using the outer layers.

FIG. 1 provides an illustrative depiction of a contactless smartcard 100 including a card inlay 105, a top outer layer 110 on a first side of card inlay 105, and a bottom outer layer 115 on a second side of card inlay 105. Card inlay 105 acts as a carrier for an antenna, a RFID IC, a mechanical switch, and other associated components as will be described in greater detail below.

It should be recognized that for the economic production of such cards, multiple cards many be produced together from larger sheets of material. These sheets will then be cut or otherwise formed into individual cards. For the purpose of clarity of this description and not a limitation, reference is made to a single card. For example, although a single card including three layers is shown in FIG. 1, each layer shown may be a complex construction of several other layers (not shown).

Card inlay 105 may resemble a payment card shape and size, including those adhering to industry standards regulating the size, shape, and configuration of payment cards. Top outer layer 110 and bottom outer layer 115 may, alone or in combination with other material layers (not shown), cooperate to retain card inlay 105 between top outer layer 110 and bottom outer layer 115.

A card lamination process may be used in a manufacturing process of card 100 to fix the relative positioning of top outer layer 110, bottom outer layer 115, and card inlay 105.

In some embodiments, card inlay 105 may be made of a material that is resistant to deformation when subjected to the heat and pressures present in a card manufacturing process, including those accompanying a lamination process. In particular, card inlay 105 may be configured to maintain its structural integrity when subjected to the combination of heat and pressures associated with a card lamination process to the extent that the constituent components of the card, e.g., an antenna, RFID IC, and other components, are not damaged when subjected to lamination pressures and heat.

It should be appreciated that the size and shape of card inlay 105 and card 100 in general may be altered, modified, or otherwise changed to accommodate specific uses, implementations, and to conform to relevant standards regarding size, shape, and configuration that are now known and those that become known in the future.

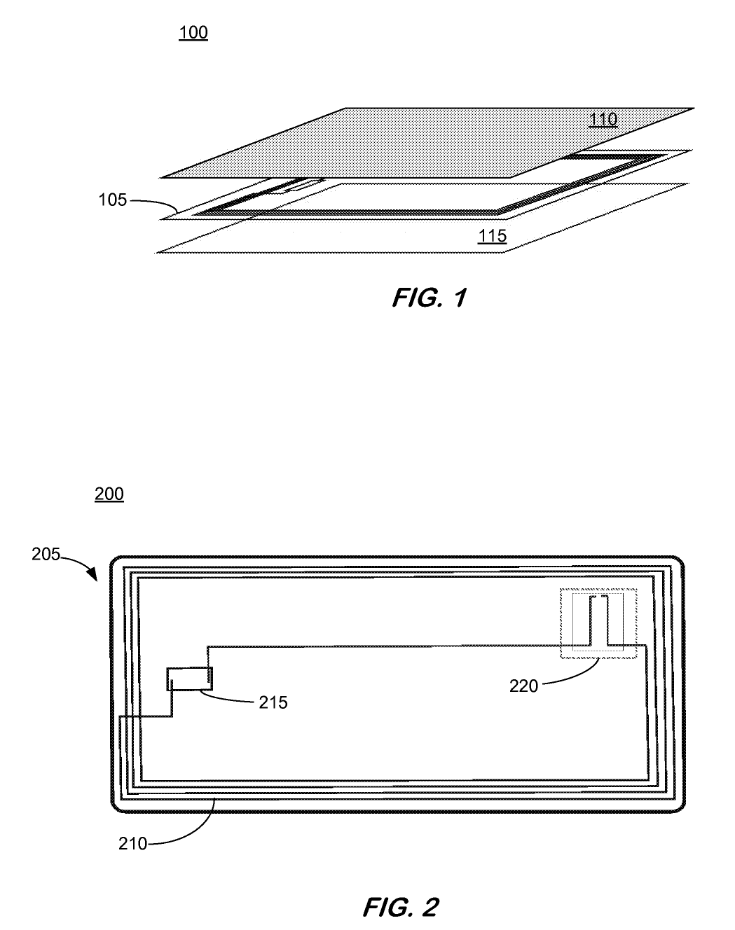

FIG. 2 provides a schematic overview of a card inlay 200. Card inlay 200 includes a carrier body 205 that supports an antenna 210, a RFID IC 215, and switch electrode structure 220. Carrier body may be flexible, thereby providing a resilient and robust structure that can withstand a card manufacturing process, as well as withstanding the hazards visited upon a card throughout the expected life cycle of the card. In some embodiments herein, antenna 210, RFID IC 215, and switch electrode structure 220 are contained either on or in card inlay 200. In some embodiments, antenna 210 includes several loops or runs of wire or conductive material on carrier body 205. Card inlay 200, including carrier body 205, antenna 210, RFID IC 215, and switch electrode structure 220 may typically have a height or thickness of about 0.5 mm or less.

As illustrated, antenna 210 may include several loops of conductive material printed, etched, deposited, or otherwise positioned on or in card inlay 200. While depicted as being located along a periphery of card inlay 205, the exact positioning, size, and configuration of antenna 210 may be altered to accommodate various custom or standard design constraints. As such, the configuration and number of turns of antenna 210 are illustrative, not limiting aspects herein. In some embodiments, electrode structure 220 may comprise antenna 210, in part or in full.

Carrier body 205, in some embodiments, is constructed of a material resistant to distortion during manufacturing and the operation pressures, stresses, and heat to which card inlay 200 is likely subjected to during the lamination process. In some embodiments, carrier body 205 may contain regions where different materials are used to ensure that a particular region of carrier body 205 is protected from distortion during manufacture. Accordingly, in some embodiments carrier body 205 will resist becoming soft during the card lamination process to an extent that components incorporated into the carrier body are damaged, or structures formed in the card carrier are distorted.

Still referring to FIG. 2, switch electrode structure 220 provides a mechanism to electrically couple RFID IC 215 and antenna 210 together in a switched circuit with a user-actuated switch. In some embodiments, electrode structure 220 is an integral part of the user-actuated mechanical switch disclosed herein. In other embodiments still, portions of antenna 10 may functionally provide connection points or terminals for the mechanical switch(es) herein.

Electrode structure 220 provides a mechanism, distinct from or part of an antenna wire or trace of antenna 210, to facilitate a reliable electrical contact between RFID IC 215, antenna 210, and the user-actuated mechanical switch disclosed herein.

Antenna 210 and RFID IC 215 may be connected to electrode structure 220 by bonding or a conductive paste, and any other method known now or that becomes known in the future that is compatible with the other aspects of the present disclosure.

In some embodiments, RFID IC 215 may be positioned on card inlay 200 in a location to minimize a potential for capacitive coupling between the conductive trace connecting electrode structure 220 and RFID IC 215 and antenna 210. Accordingly, RFID IC 215 is positioned away from antenna 210 in FIG. 2.

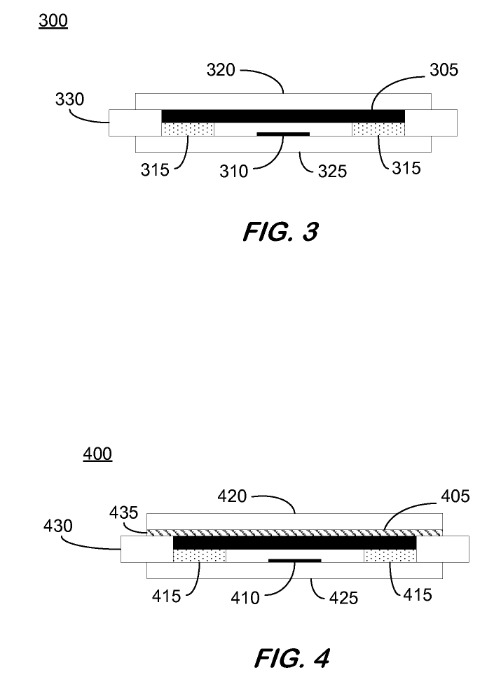

FIG. 3 provides an illustrative depiction of some aspects of a smartcard 300 (or an inner layer within the smartcard) incorporating a mechanical switch consistent with the present disclosure. In particular, a top electrode structure 305 and a base electrode 315 are provided between an upper outer layer 320 and a lower outer layer 325. Upper outer layer 320 and lower outer layer 325 may comprise plastic laminate layers of smartcard 300.

Positioned between top electrode 305 and base electrode 315 to maintain separation between the top electrode and the base electrode is a layer of compressible material 315. Compressible material 315 does not fill a full extent of the area between top electrode 305 and base electrode 315. Instead, at least a portion of the area between top electrode 305 and base electrode 315 is left uncovered or unoccupied by compressible material 315. In this manner, top electrode 305 may be forced into contact with base electrode 310 when a downward (upward) force is registered against upper (lower) outer layer 320 (325), thereby compresses compressible layer 315 and urging top electrode 305 and base electrode 315 into contact with each other at the exposed area(s) between the electrodes. Compensation layer 330 provides, at least in some embodiments, a layer of material to compensate for a void created by the card inlay between upper outer layer 320 and lower outer layer 325.

In an operation to actuate the mechanical switch of smartcard 300, compressible material 315 is compressed when a force is applied to the card, thereby reducing the gap separating top electrode 305 and base electrode 310 such that an electrical connection is established between the conductive top electrode and the conductive base electrode. In this manner, RFID IC 215 may be selectively connected to antenna 210 in a closed circuit. As the compressible material may only partly compress, either the base or top electrode may, in some embodiments, protrude towards the opposing electrode such that contact is made between the electrodes.

In some embodiments, a card inlay including the mechanical switch disclosed herein may be formed from a number of constituent parts during the manufacture of the inlay and/or card. In other embodiments, the mechanical switch may be provided as a distinct assembled component that is provided on or in the card inlay at the appropriate time during the card or card inlay manufacturing process.

In some instances herein, the mechanical switch is at least partially located in a cavity in card inlay 105. Locating the switch at least partially in a cavity in the card inlay may facilitate producing a card and/or card inlay that does not exceed a maximum card and/or card inlay height restriction. Further minimizing or eliminating vertical features, or the edges of materials in the structure, will contribute to a uniform card or card inlay that meets design and technical specifications.

In some embodiments, compressible material 315 may have a thickness of about 100 μm and about 300 μm.

In some embodiments, top electrode 305 may be a rigid structured comprising a thin conductive (e.g., metal) plate. In some embodiments, a conductive (e.g., metallic) area may be applied to an underside of the upper outer layer 320 (or other layers) immediately above and opposing base electrode 310.

In some embodiments, particularly embodiments where top electrode 305 comprises a rigid conductive plate, the conductive plate may not be adhered to the layer immediately above it (e.g., upper outer layer 320). In this manner, top electrode 305 may be free to flex, bend, or otherwise move a rate or extent different than the upper outer layer.

In some embodiments, top electrode 305 may be assured of being free to move in response to an applied pressure by being separated from upper outer layer 320 by way of the composition materials of upper outer layer 320 and top electrode 305 and/or a coating or layer of material disposed between upper outer layer 320 and top electrode 305. FIG. 4 provides an illustration of a smartcard similar to the smartcard of FIG. 3 where similar components are similarly referenced (i.e., 305 and 405 refer to upper outer layer, etc.) Unique to FIG. 4, a layer of material 435 may be provided between an upper (lower) electrode 405 (410) of a mechanical sensitive switch and an upper (lower) outer layer 420 (425) of a card 400. The layer of material 435 may provide a mechanism to keep the upper (lower) outer layer 420 (425) from adhering to or otherwise bonding to the mechanical switch that includes top (base) electrode 405 (410). The material may be implemented in the form of a tape, film, spray-on application, spacer, etc. In some embodiments, the material be a polyimide film such as Kapton® tape provided by E. I. du Pont de Nemours and Company.

Due to the operational force applied to the smartcard herein, 300, 400, the size and rigidity of an electrode such as top electrode 305, 405 may be limited and an edge profile of the electrode may be designed to distribute forces over a large area. For example, the size of the switch structure (e.g., 220) may be of the order of about 16 mm whereas the height of the gap separating the top and base electrodes may be on the order of about 0.1 mm.

It is noted that the size of exposed electrodes may be dependant on the gap between the electrodes and the amount of distortion that can be reasonably expected in the electrodes during the life of the card. Although the electrodes would always return to their original shape after the force required to activate the switch is removed in an optimum situation, over time and multiple operations the electrodes or card may permanently distort to reduce the gap between the electrodes. Accordingly, a purpose of the compressible material is to maintain a reliable gap between the opposing electrodes during the entire operational life-cycle of the card.

In some embodiments, compressible materials such as carbon nanotubes, microcellular foams, and cross linked polyolefin foams have exhibited properties suitable for providing the compressible material 315, 415. For example, carbon nanotubes have been shown to behave like compressible springs, withstand about 10,000 cycles of compression without collapsing, as well as having a high heat resistance. Additionally, microcellular foams having a cell size of about (1-10) μm and cross-linked polyolefin foams having a cell size of about (20-100) μm have also exhibited characteristics consistent with those needed for the compressible material 315, 415 herein.

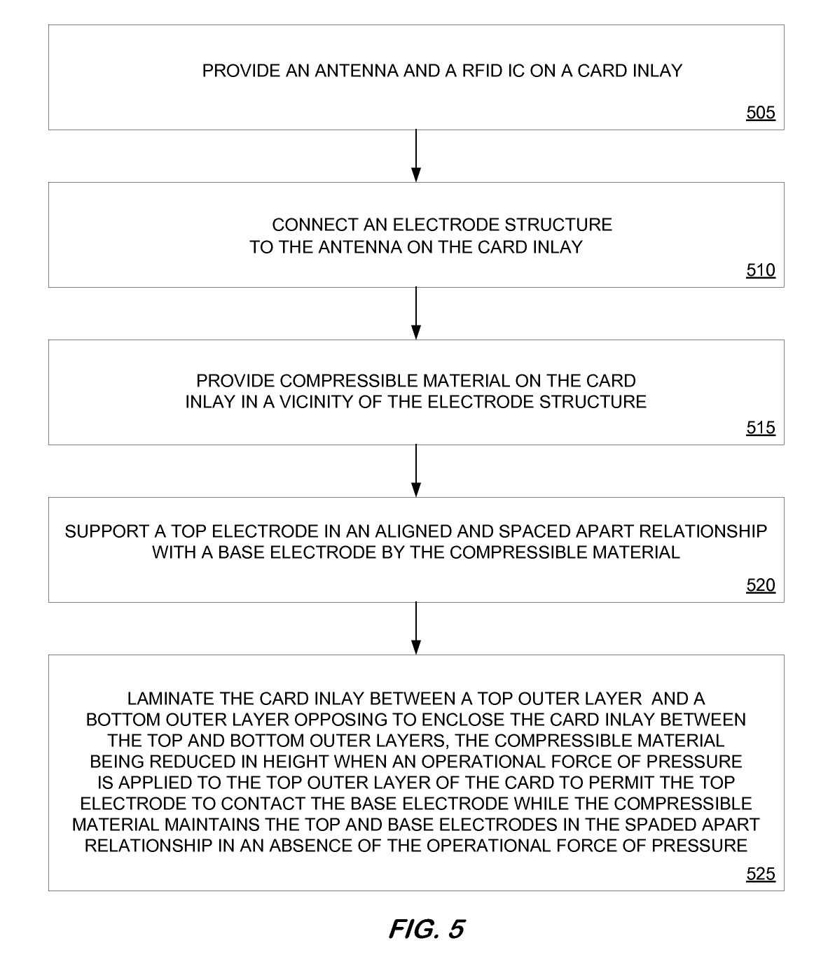

FIG. 5 is a flow diagram of a process 500 that may be used in manufacturing a smartcard or card inlay, in agreement with various aspects herein. At operation 505, an antenna and RFID IC are provided on a card inlay. The manufacturing process continues at operation 510 wherein an electrode switch structure is connected to the antenna on or in the card inlay. In some embodiments, the electrode structure switch is provided as an extension or part of the antenna, while in other embodiments that electrode switch structure is a distinct device coupled to the antenna.

At operation 515, a compressible material is located, disposed, or otherwise provided in a vicinity of the electrode switch structure. In some embodiments, the compressible material may be placed along a peripheral boundary of the electrode switch structure.

At operation 520, the top electrode of the electrode switch structure may be supported by the compressible material in an aligned and spaced apart relationship with the base electrode. It is noted that the compressible material does not completely fill an area between the top and base electrodes. Instead, at least a portion of the area between the top and base electrodes remains uncovered by the compressible material so that, when a compressive pressure is applied to the smartcard to actuate the mechanical switch, the top and base electrodes may establish conductive contact with each other.

At operation 525, the smartcard may be laminated using a lamination process. The lamination process may apply a combination of heat and pressure to the card inlay including the antenna, RFID IC, mechanical switch having top and base electrodes between a top outer layer adjacent a first side of the card inlay and a bottom outer layer adjacent a second side of the card inlay opposing the first side of the card inlay to enclose the card inlay between the top and bottom outer layers.

In some embodiments herein, a card inlay may be produced using some of the operations of process 500. That is, the card inlay may be produced as a separate or pre-stage operation prior to laminating the card inlay into a card during a card laminating process.

By incorporating a mechanical switch in an inlay in the manner disclosed herein, it may be possible to incorporate a user-actuated switch in a smartcard while minimizing changes in the card manufacturing process, and also minimizing increases in manufacturing cost.

Although not specifically indicated in the drawings, one or more of the contactless smartcards herein may have a contact interface like that of a conventional card that includes a contact interface.

In some embodiments (not shown), the switch structure of the smartcard may not be connected directly to the antenna circuit, but instead via other circuit paths and/or components to the RFID IC 215. In such cases, RFID IC 215 may not support an antenna or RF interface.

The above description and/or the accompanying drawings are not meant to imply a fixed order or sequence of steps for any process referred to herein; rather any process may be performed in any order that is practicable, including but not limited to simultaneous performance of steps indicated as sequential.

The contactless smartcards may also be applicable to contactless smart cards generally, as well as to so-called “dual interface” smart cards, which contain a set of contacts on a surface of the card to allow for direct contact interface to a terminal. “Dual interface” smart cards also include an antenna to allow for interfacing to a terminal by wireless transmission of signals.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A radio frequency identification (RFID) card, the card comprising:
a card inlay;
an antenna positioned on the card inlay;
a RFID integrated circuit (IC) located on the card inlay;
an electrode structure;
a switch located on or in the card inlay and, when actuated, coupled to the antenna and the RFID IC via the electrode structure, the switch comprising:
a conductive layer aligned with but positioned spaced apart from the electrode structure; and
a compressible material to hold the conductive layer in the spaced apart position and to compress under pressure when the switch is actuated to permit the conductive layer to contact the electrode structure.

2. The card of claim 1, wherein the conductive layer is rigid and does not flex when the switch is actuated.

3. The card of claim 1, wherein the card inlay is enclosed between an upper outer layer and a lower outer layer, top outer layer of the card is planar and an operational force of pressure is applied to the top outer layer to actuate the switch.

4. The card of claim 1, wherein the compressible material is not placed in an area where the conductive layer and the electrode structure are aligned to contact each other.

5. The card of claim 1, wherein the compressible material is one of carbon nanotubes and microcellular foams having a cell size of about 1 μm to about 100 μm.

6. The card of claim 1, wherein the compressible material has a thickness of about 100 μm to about 300 μm.

7. The card of claim 1, wherein the antenna comprises the electrode structure.

8. The card of claim 1, further comprising a layer of material between the top outer layer adjacent the first side of the card inlay and the conductive layer of the switch, the layer of material preventing the top outer layer adjacent the first side of the card inlay from adhering to the switch.

9. The card of claim 1, wherein the switch is at least partially disposed in a cavity in the card inlay.

10. The card of claim 1, wherein the card inlay includes a plurality of layers of material.

11. A method of manufacturing a radio frequency identification (RFID) card, the method comprising:
providing an antenna and a RFID integrated circuit (IC) on a card inlay;
connecting an electrode structure to the antenna on the card inlay;
providing a compressible material on the card inlay in a vicinity of the electrode structure;
supporting a top electrode in an aligned and spaced apart relationship with a base electrode by the compressible material, and
laminating the card inlay including the antenna, electrode structure, compressible material, and conductor layer between a top outer layer adjacent a first side of the card inlay and a bottom outer layer adjacent a second side of the card inlay opposing the first side of the card inlay to enclose the card inlay between the top and bottom outer layers, the compressible material being reduced in height when an operational force of pressure is applied to the top outer layer of the card to permit the top electrode to contact the base electrode while the compressible material maintains the top and base electrodes in the spaded apart relationship in an absence of the operational force of pressure.

12. The method of claim 11, wherein an exterior surface of the top outer layer over a vicinity of the top electrode is substantially flat and planar.

13. The method of claim 11, wherein the electrode structure comprises at least a portion of the antenna.

14. The method of claim 11, wherein the card inlay comprises a plurality of layers.

15. The method of claim 11, further comprising ensuring an outer surface of the conductor that is subjected to pressure during operation is not bonded to an adjacent layer of the RFID card.

16. The method of claim 15, wherein the ensuring comprises placing a barrier layer between the conductor layer and the outer layer adjacent to the conductive layer.

17. The method of claim 11, wherein the compressible material is at least one of carbon nanotubes, a microcellular foam, and a combination thereof.

18. The method of claim 11, wherein the compressible material has a thickness of about 100 μm to about 300 μm.

19. The method of claim 11, wherein a plurality of the card inlays are produced from a common sheet of material.

20. The method of claim 19, wherein the sheet of material proceeds through at least some operations of a manufacturing process intact to produce the plurality of card inlays substantially simultaneously.
